(19) United States
(12) Patent Application Publication
(10) Pub. No.: US 2026/0204919 A1
(43) Pub. Date: Jul. 16, 2026

(54) ELECTRIC POWER SYSTEM AND METHOD FOR OPERATING THE SAME

(71) Applicant: DELTA ELECTRONICS, INC., Taoyuan City (TW)

(72) Inventors: Yi-Kuan KE, Taoyuan City (TW); Li-Quan XIAO, Taoyuan City (TW); Chia-Ching LIN, Taoyuan City (TW); Wen-Ching CHANG, Taoyuan City (TW)

(21) Appl. No.: 19/379,773

(22) Filed: Nov. 5, 2025

Related U.S. Application Data
(60) Provisional application No. 63/745,800, filed on Jan. 16, 2025.

(30) Foreign Application Priority Data
Aug. 19, 2025 (CN) 202511159135.7

(51) Int. Cl. H02J 3/38; H02J 3/00; H02J 3/28

(52) U.S. Cl. CPC H02J 3/388; H02J 3/00125; H02J 3/0073; H02J 3/28

(57) ABSTRACT

An electric power system comprises an utility power grid connected to a first switch; and a microgrid connected to the utility power grid through the first switch, the microgrid comprising: inverter devices connected to a bus; a controller connected to the first switch and the inverter devices, and configured to transmit first signals; and loads connected to the inverter devices through the bus, wherein the utility power grid is connected to the bus through the first switch, and is configured to provide power to the loads, the controller is further configured to detect a first lane connecting the utility power grid with the microgrid and determine whether the first lane is abnormal, and when the first lane is abnormal, the controller cuts off the first switch, and switches a first part of the inverter devices to a voltage source configuration through the first signals.

### CROSS-REFERENCE TO RELATED APPLICATIONS

This application claims priority to China Application Serial Number 202511159135.7, filed on Aug. 19, 2025 and U.S. Provisional Application Ser. No. 63/745,800, filed on Jan. 16, 2025, which are herein incorporated by reference.

### BACKGROUND

### Technical Field

The present disclosure relates to an electric power system. More particularly, the present disclosure relates to an electric power system having multiple inverter devices with power mode switching functionality, and method of operating the same.

### Description of Related Art

In the existing electric power system, the microgrid in the infrastructure combining microgrid with the local area network or utility power grid uses feeder lines to encompass the service region, and utility power grid provides electricity to the microgrid for powering the loads. When the utility power grid at the upstream of the feeder lines encounters abnormality, the loads can only be powered by the microgrid in islanded operation. Not until the abnormality is resolved would the reconnection to the utility power grid be recovered. At this moment, the power distribution and the powering capacity of the islanded microgrid require further consideration to obtain sufficient source of charges.

### SUMMARY

The present disclosure provides an electric power system. The electric power system comprises: an utility power grid connected to a first switch; and a microgrid connected to the utility power grid through the first switch, the microgrid comprising: a plurality of inverter devices connected to a bus; a controller connected to the first switch and each of the plurality of inverter devices, and configured to transmit a plurality of first signals; and a plurality of loads connected to the plurality of inverter devices through the bus, wherein the utility power grid is connected to the bus through the first switch, and is configured to provide power to the plurality of loads, the controller is further configured to detect a first lane connecting the utility power grid with the microgrid, and determine whether the first lane is abnormal, and when the controller determines the first lane is abnormal, the controller cuts off the first switch, and switches a first part of the plurality of inverter devices to a voltage source configuration through the plurality of first signals.

The present disclosure provides a method for operating an electrical power system. The method comprises: connecting an utility power grid to a plurality of microgrids respectively through a plurality of lanes by a plurality of switches; detecting a plurality of voltages of the plurality of switches, and determining whether the plurality of lanes are abnormal according to the plurality of voltages; when determining a first lane of the plurality of lanes is abnormal, cutting off a first switch of the plurality of switches, and switching a first part of a plurality of inverter devices in a first microgrid of the plurality of microgrids to a voltage source configuration; and when determining the first lane is normal, remained throwing in the first switch, and each of the plurality of inverter devices operates under a current source configuration being different from the voltage source configuration, wherein when determining the first lane is abnormal, a second part the plurality of inverter devices operate under the current source configuration, and the second part is different from the first part.

It is to be understood that both the foregoing general description and the following detailed description are by examples, and are intended to provide further explanation of the disclosure as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an electric power system, illustrated in accordance with some embodiments of the present disclosure.

FIG. 2 is a schematic diagram of an electric power system, illustrated in accordance with some embodiments of the present disclosure.

FIG. 3 is a flowchart diagram of an operating method for operating an electric power system, illustrated in accordance with some embodiments of the present disclosure.

FIG. 4 is a schematic diagram of an electric power system, illustrated in accordance with some embodiments of the present disclosure.

FIG. 5 is a schematic diagram of an electric power system, illustrated in accordance with some embodiments of the present disclosure.

### DETAILED DESCRIPTION

In the present disclosure, when an element is referred to as “connected” or “coupled”, it may mean “electrically connected” or “electrically coupled”. “Connected” or “coupled” can also be used to indicate that two or more components operate or interact with each other. In addition, although the terms “first”, “second”, and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present invention belongs. It will be further understood that terms (such as those defined in commonly used dictionaries) should be interpreted as having a meaning consistent with its meaning in the related technology and/or the context of this specification and not it should be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

Hereinafter multiple embodiments of the present disclosure will be disclosed with schema, as clearly stated, the details in many practices it will be explained in the following description. It should be appreciated, however, that the details in these practices is not applied to limit the present disclosure. Also, it is to say, in some embodiments of the present disclosure, the details in these practices are non-essential. In addition, for the sake of simplifying schema, some known usual structures and element in the drawings by a manner of simply illustrating for it.

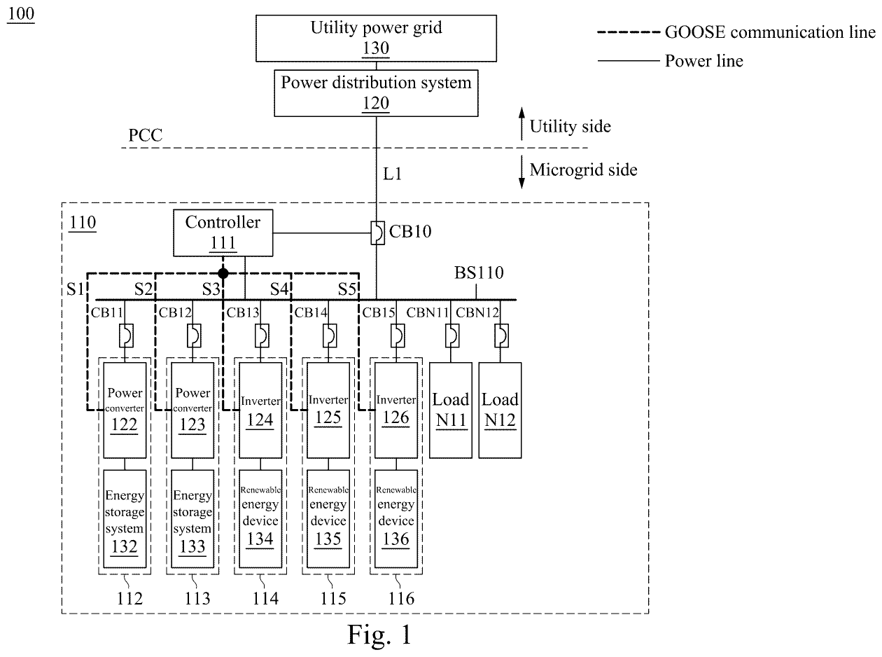

FIG. 1 is a schematic diagram of an electric power system 100, illustrate in accordance with some embodiments of the present disclosure. As illustratively shown in FIG. 1, the electric power system 100 includes a microgrid 110, a power distribution system 120, and a utility power grid 130. In some embodiments, the microgrid 110 is separated with the power distribution system 120 and the utility power grid 130 through a point of common coupling (PCC) to divide into a utility side and a microgrid side.

As illustratively shown in FIG. 1, the microgrid 110 includes a controller 111, multiple inverter devices 112-116, multiple loads N11 and N12, and multiple switches CB10-CB15, CBN11 and CBN12. In some embodiments, the inverter device 112 includes a power converter 122 and an energy storage system 132. The inverter device 113 includes a power converter 123 and an energy storage system 133. The inverter device 114 includes an inverter 124 and a renewable energy device 134. The inverter device 115 includes an inverter 125 and a renewable energy device 135. The inverter device 116 includes an inverter 126 and a renewable energy device 136.

As illustratively shown in FIG. 1, the power converter 122 is connected to the energy storage system 132, and connected to a bus BS110 through the switch CB11. The power converter 123 is connected to the energy storage system 133, and connected to a bus BS110 through the switch CB12. The inverter 124 is connected to the renewable energy device 134, and connected to a bus BS110 through the switch CB13. The inverter 125 is connected to the renewable energy device 135, and connected to a bus BS110 through the switch CB14. The inverter 126 is connected to the renewable energy device 136, and connected to a bus BS110 through the switch CB15. The load N11 is connected to the bus BS110 through the switch CBN11. The load N12 is connected to the bus BS110 through the switch CBN12.

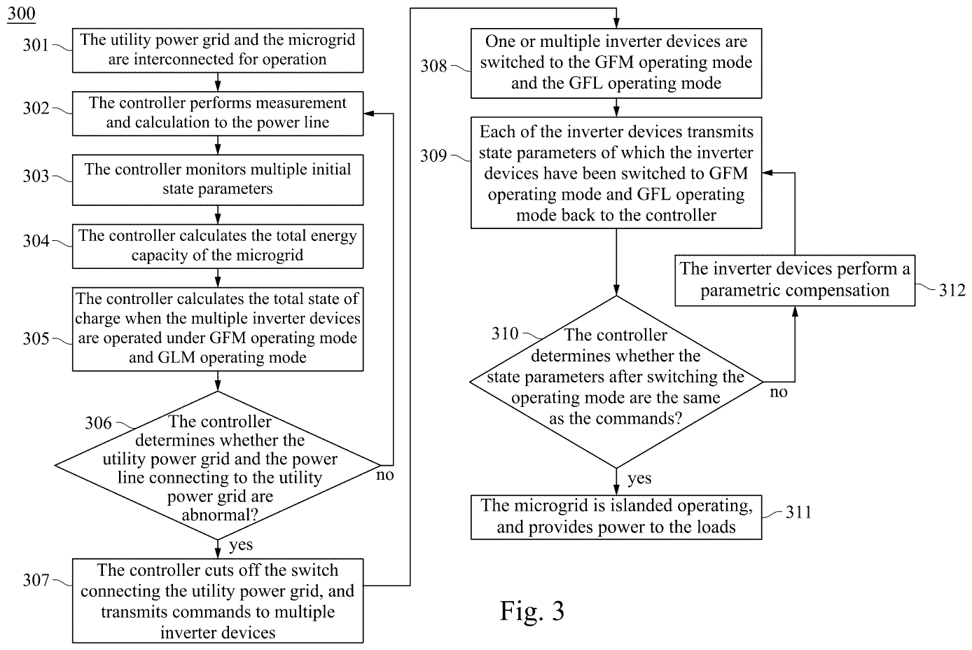

In some embodiments, the utility power grid 130 is connected to the power distribution system 120. The power distribution system 120 is connected to the switch CB10 through a lane L1, and the switch CB10 is connected to the bus BS110 configured to distribute the electricity to the microgrid 110. The controller 111 is connected to the switch CB10, and is configured to detect parameters on the utility side and control the throw in and cut off of the switch CB10. Further details regarding the detection of the parameters on the utility side and the control of the switch CB10 are discussed in FIG. 3 and the corresponding paragraphs of the present disclosure.

In some circumstances, when the utility power grid 130 operates normally, and the switch CB10 is thrown in, the utility power grid 130 is configured to distribute electricity to the microgrid 110, and provides power to the loads N11 and N12, or charges the energy storage systems 132 and 133. The utility power grid 130 is configured to provide power to the load, or charges the energy storage system according to the operation status of the microgrid 110. In some other circumstances, when the utility power grid 130 operates abnormally, and the switch CB10 is cut off, the utility power grid 130 is disconnected with the microgrid 110, and the energy storage systems 132 and 133 and the renewable energy devices 134-136 are configured to provide power to the loads N11 and N12. Further details regarding the determination of whether the utility power grid 130 operates normally or abnormally and the microgrid 110 that provides power the loads N11 and N12 are discussed in FIG. 3 and the corresponding paragraphs of the present disclosure.

In some embodiments, when the utility power grid 130 is normal, each of the inverter devices 112-116 operates in the Grid-Following (GFL) operating mode. Specifically, when the inverter devices 112-116 are operating in GFL operating mode, the inverter devices 112-116 operate in current source configuration. At this moment, the power converters 122-123 and the inverters 124-126 operate based on the voltage and the frequency provided by the utility power grid 130.

In some embodiments, when the utility power grid 130 is abnormally, or when the microgrid 110 is islanded operating, a part of the inverter devices 112-116 is switched to the Grid-Forming (GFM) operating mode. Specifically, when one or multiple inverter devices 112-116 are operating in GFM operating mode, the inverter devices 112-116 operate in voltage source configuration. At this moment, the power converters 122-123 and the inverters 124-126 generate the voltage and the frequency independently to provide power to each of the loads N11 and N12. In some embodiments, the term islanded indicates that when the switch CB10 connecting the microgrid 110 and the utility power grid 130 is cut off, the microgrid 110 operates independently to provide power to each of the loads N11 and N12.

As illustratively shown in FIG. 1, the controller 111 controls the inverter devices 112-116 by signals S1-S5 respectively, and is configured to switch the operating mode of the inverter devices 112-116. Specifically, the controller 111 switches the inverter devices 112-116 from the GFL operating mode to the GFM operating mode, and/or from the GFM operating mode to the GFL operating mode through the signals S1-S5, respectively. In some embodiments, each of the signals S1-S5 can be implemented by optical fiber or control cable, and the controller 111 transmits the signals S1-S5 respectively to the power converters 122-123 and the inverters 124-126 through the virtual channels of power interoperability. In some embodiments of the present disclosure, the signals S1-S5 can be implemented by the virtual channels conformed to the communication technology of Generic Object Oriented Substation Event (GOOSE).

In some embodiments, each of the power distribution system 120, the utility power grid 130, the controller 111, the inverter devices 112-116, the loads N11 and N12, and the switches CB10-CB15, CBN11 and CBN12 in the electric power system 100 is connected to each other through power lines. In some embodiments, the controller 111 transmits the signals S1-S5 respectively to the inverter devices 112-116 through the GOOSE communication lines.

In the embodiment of the present disclosure, each of the switches CB11-CB15, CBN11 and CBN12 is operated under thrown-in configuration. Alternatively stated, when the microgrid 110 is operating, each of the switches CB11-CB15, CBN11 and CBN12 is turned on.

In some embodiments, the inverter devices 112-116 can be implemented by the Inverters Base Resources (IBRs). The power converters 122-123 can be implemented by the Power Conversion System (PCS). The energy storage systems 132-133 can be implemented by the Battery Energy Storage System (BESS). The inverters 124-126 can be implemented by the Photovoltaic Inverter (PV Inverter). The renewable energy devices 134-136 can be implemented by the Photovoltaic Array (PV Array). In some embodiments, the renewable energy devices 134-136 can also be implemented by the power generators or the renewable energy sources, such as solar power system, wind power system, hydroelectric power system, and geothermal power system; however the present disclosure is not limited to the power systems mentioned above.

In some embodiments, the power distribution system 120 can be located in the substation or associated facilities, and is configured to distribute the electricity provided by the utility power grid 130 to multiple different microgrids.

In some embodiments, the loads N11-N12 are general electricity consumptions having a lower instantaneous load power. In some other embodiments, the loads N11-N12 can be Electric Vehicle (EV) power consumptions having a higher instantaneous load power. For example, the general electricity consumptions could have 0.05-5.0 kilo watt per hour (kWh) of instantaneous load power, the EV power consumptions could have 20-400 kWh of instantaneous load power.

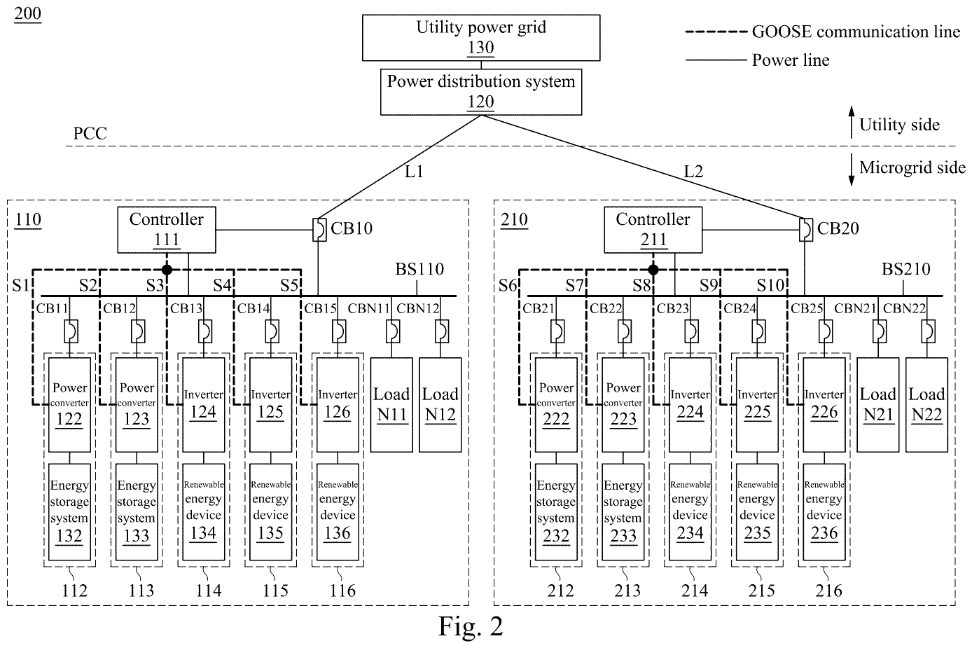

FIG. 2 is a schematic diagram of an electric power system 200, illustrated in accordance with some embodiments of the present disclosure. As illustratively shown in FIG. 2, the electric power system 200 includes all the components of the electric power system 100. The electric power system 200 further includes a microgrid 210.

In some embodiments, the electric power system 200 is another embodiment of the electric power system 100. In various embodiments, the electric power systems 100 and 200 may include one or more microgrids, such as the microgrids 110 and 210, but the present disclosure is not limited to this.

As illustratively shown in FIG. 2, the microgrid 210 includes a controller 211, multiple inverter devices 212-216, multiple loads N21 and N22, and multiple switches CB20-CB25, CBN21 and CBN22. In some embodiments, the inverter device 212 includes a power converter 222 and an energy storage system 232. the inverter device 213 includes a power converter 223 and an energy storage system 233. The inverter device 214 includes an inverter 224 and a renewable energy device 234. The inverter device 215 includes an inverter 225 and a renewable energy device 235. The inverter device 216 includes an inverter 226 and a renewable energy device 236. In some embodiments, the connecting relationship between various components in the microgrid 210 and the operating method are similar to the microgrid 110. The similarities between the microgrids 210 and 110 are not repeated herein for simplicity.

As illustratively shown in FIG. 2, the power converter 222 is connected to the energy storage system 232, and is connected to the bus BS210 through the switch CB21. The power converter 223 is connected to the energy storage system 233, and is connected to the bus BS210 through the switch CB22. The inverter 224 is connected to the renewable energy device 234, and is connected to the bus BS210 through the switch CB22. The inverter 225 is connected to the renewable energy device 235, and is connected to the bus BS210 through the switch CB22. The inverter 226 is connected to the renewable energy device 236, and is connected to the bus BS210 through the switch CB22. The load N21 is connected to the bus BS210 through the switch CBN21. The load N22 is connected to the bus BS210 through the switch CBN22.

In some embodiments, the power distribution system 120 is connected to the switch CB20 through the lane L2, and the switch CB20 is connected to the bus BS210 configured to distribute the electricity to the microgrid 210. The controller 211 is connected to the switch CB20, and is configured to detect parameters on the utility side and control the throw in and cut off of the switch CB20. Further details regarding the detection of the parameters on the utility side and the control of the switch CB20 are discussed in FIG. 3 and the corresponding paragraphs of the present disclosure. In some embodiments, the independent operation of the microgrid 210 is similar to the microgrid 110. Therefore, the similarities between the operation of the microgrids 210 and 110 are not discussed herein for simplicity.

In some circumstances, when the utility power grid 130 operates normally, and each of the switches CB10 and CB20 is thrown in, the utility power grid 130 is configured to distribute the electricity to each of the microgrids 110 and 210, and is configured to provide power to the loads N11, N12, N21, and N22.

In some other circumstances, when the utility power grid 130 operates abnormally, and each of the switches CB10 and CB20 is cut off, the utility power grid 130 is disconnected with each of the microgrids 110 and 210. The energy storage systems 132 and 133 and the renewable energy devices 134-136 are configured to provide power to the loads N11 and N12. The energy storage systems 232 and 233 and the renewable energy device 234-236 are configured to provide power to the loads N21 and N22.

In yet some other circumstances, when the utility power grid 130 operates normally, and one of the switches CB10 and CB20 is cut off, the microgrid, corresponding to the switches CB10 and CB20 that has been cut off, is islanded. The electricity is provided to the microgrid, corresponding to the switches CB10 and CB20 that has not been cut off, by the utility power grid 130. For example, when the utility power grid 130 operates normally, the switch CB10 is cut off, and the switch CB20 is thrown in, the utility power grid 130 is configured to distribute electricity to the microgrid 210, configured to provide power to the loads N21 and N22. In the meantime, the utility power grid 130 is disconnected with the microgrid 110, such that the microgrid 110 is islanded. The energy storage systems 132 and 133 and the renewable energy devices 134-136 are configured to provide power to the loads N11 and N12.

As illustratively shown in FIG. 2, the controller 211 controls the inverter devices 212-216 respectively through the signals S6-S10, and is configured to switch the operating mode of the inverter devices 212-216. Specifically, the controller 211 switches the inverter devices 212-216 from the GFL operating mode to the GFM operating mode, and/or from the GFM operating mode to the GFL operating mode respectively through the signals S6-S10. In some embodiments, the signals S6-S10 can be implemented by the virtual channels conformed to the communication technology of GOOSE.

In some embodiments, when the utility power grid 130 is operating normally, each of the inverter devices 112-116 and 212-216 is operating under the GFL operating mode. At this moment, each of the inverter devices 112-116 and 212-216 operate in current source configuration.

In some other embodiments, when the utility power grid 130 is operating abnormally, a part of the inverter devices 112-116 and 212-216 is switched to the GFM operating mode. At this moment, the inverter devices 112-116 and 212-216 operate in voltage source configuration. In some embodiments, a part of the inverter devices 112-116 and 212-216 includes one or more of the inverter devices 112-116, and/or one or more of the inverter devices 212-216.

In some embodiments, each of the controller 211, the inverter devices 212-216, the loads N21 and N22, and the switches CB20-CB25, CBN21 and CBN22 is connected to each other through the power line. In some embodiments, the controller 211 transmits the signals S6-S10 to the inverter devices 212-216 respectively through the GOOSE communication line.

In the embodiment of the present disclosure, each of the switches CB21-CB25, CBN21 and CBN22 is operated under thrown-in configuration. Alternatively stated, when the microgrid 210 is operating, each of the switches CB21-CB25, CBN21 and CBN12 is turned on.

In some embodiments, the inverter devices 212-216 can be implemented by the IBRs. The power converters 222-223 can be implemented by the PCS. The energy storage systems 232-233 can be implemented by the BESS. The inverters 224-226 can be implemented by the PV inverter. The renewable energy devices 234-236 can be implemented by the PV array.

In some embodiments, the loads N21-N22 are general electricity consumptions having a lower instantaneous load power. In some other embodiments, the loads N21-N22 can be Electric Vehicle (EV) power consumptions having a higher instantaneous load power.

FIG. 3 is a flowchart diagram of an operating method 300 for operating an electric power system 100 or 200, illustrated in accordance with some embodiments of the present disclosure. As illustratively shown in FIG. 3, the operation method 300 includes operations 301-312. In some embodiments, the operation method 300 can be applied to the electric power systems 100 and 200. The following embodiments are discussed with the electric power system 200 hereafter to illustrate the operation method 300.

In the operation 301, when the electric power system 200 is operating, each of the utility power grid 130 and the microgrid 110 and 210 are interconnected for operation.

Specifically, when the electric power system 200 is operating, the microgrid 110 and the microgrid 210 throw in the switches CB10 and CB20, respectively. At this moment, the utility power grid 130 distributes the electricity to each of the microgrid 110 and the microgrid 210 through the power distribution system 120 to provide power to the loads N11, N12, N21 and N22. The electric power system 200 performs the operation 302 after the operation 301 is performed.

In the operation 302, the controllers 111 and 211 perform measurement to the lanes L1 and L2 respectively, and calculate parameters on the utility side.

Specifically, the controller 111 measures multiple parameters between the power distribution system 120 and the switch CB10 through the lane L1. The controller 211 measures multiple parameters between the power distribution system 120 and the switch CB20 through the lane L2. The multiple parameters include voltages V_CB10 and V_CB20, currents I_CB10 and I_CB20, and frequencies F_CB10 and F_CB20 respectively between the switch CB10 and the power distribution system 120 and between the switch CB20 and the power distribution system 120. However, the present disclosure is not limited to these parameters mentioned above.

In some embodiments, the controllers 111 and 211 can measure the parameters of the lanes L1 and L2 through the relay and the voltmeter. The electric power system 200 performs the operation 303 after the operation 302 is performed.

In the operation 303, the controllers 111 and 211 respectively monitor multiple initial state parameters of the inverter devices 112-116 and 212-216.

Specifically, the inverter devices 112-116 transmit the corresponding initial state parameters to the controller 111 through the signals S1-S5. The inverter devices 212-216 transmit the corresponding initial state parameters to the controller 211 through the signals S6-S10.

In some embodiments, the initial state parameters of the inverter devices 112-116 include the operation status of the inverter devices 112-116 and the energy capacities S112_GFL-S116_GFL of the inverter devices 112-116 operating under the GFL operating mode. The initial state parameters of the inverter devices 212-216 include the operation status of the inverter devices 212-216 and the energy capacities S212_GFL-S216_GFL of the inverter devices 212-216 operating under the GFL operating mode. In some embodiments, each of the energy capacities S112_GFL-S116_GFL and S212_GFL-S216_GFL has a unit of kilowatt per hour (kWh) or megawatt per hour (MWh). The electric power system 200 performs the operation 304 after the operation 303 is performed.

In the operation 304, the controllers 111 and 211 respectively calculate the total energy capacity of the microgrids 110 and 210.

Specifically, the controller 111 calculates the total energy capacity ST1_GFL of the microgrid 110, when the inverter devices 112-116 are operating under the GFL operating mode, and when the inverter devices 112-116 are operating under the GFM operating mode. Similarly, the controller 211 calculates the total energy capacity ST2_GF of the microgrid 210, when the inverter devices 212-216 are operating under the GFL operating mode, and when the inverter devices 212-216 are operating under the GFM operating mode.

In some embodiments, the total energy capacities ST1_GFL and ST2_GFL are calculated according to the following equation.

$$ST\_GFL ( t ) = {\sum }_{i}^{N i} ( S\_PCS \_GFL \_i ( t ) ) + {\sum }_{j}^{Nj} ( S\_PV \_GFL \_j ( t ) \times B\_j ( t ) ) \qquad ( 1 )$$

Wherein Ni, Nj, i and j are positive integers being larger than zero.

In the equation (1), the total energy capacity ST_GFL (t) is configured to indicate the total energy capacity of the microgrid operating under the GFL operating mode at the time t, such as the total energy capacities ST1_GFL and ST2_GFL.

In the equation (1), the energy capacity S_PCS_GFL_i (t) is configured to indicate the total energy capacity of the inverter devices, which are implemented by PCS, operating under the GFL operating mode at the time t. Wherein the integer Ni is configured to indicate a quantity of the inverter devices being implemented by the PCS in the microgrid, such as the inverter devices 112 and 113. The integer i is configured to indicate the i-th inverter device being implemented by the PCS. For example, the integer i being equal to 1 indicates the inverter device 112, and the integer i being equal to 2 indicates the inverter device 113.

In the equation (1), the energy capacity S_PV_GFL_j (t) is configured to indicate the total energy capacity of the inverter devices, which are implemented by inverters, operating under the GFL operating mode at the time t. Wherein the integer Nj is configured to indicate a quantity of the inverter devices being implemented by the inverters, such as the inverter devices 114-116. The integer j is configured to indicate the j-th inverter devices being implemented by the inverters. For example, the integer j being equal to 1 indicates the inverter device 114, the integer j being equal to 2 indicates the inverter device 115, and the integer j being equal to 3 indicates the inverter device 116. In some embodiments, the energy capacity S_PV_GFL_j is configured to indicate the energy capacity of the PV inverter.

In some embodiments, the parameter B_j (t) in the equation (1) is configured to indicate a percentage of maximum power point (MPP) of the j-th PV inverter at the time t. In some embodiments, the parameter B_j is represented by percentage or decimal point, such as 20% or 0.2. However, the present disclosure is not limited to these representation and values.

In some embodiments, the energy capacities S1_GFM and S2_GFM are calculated according to the total energy capacities ST1_GFL and ST2_GFL. Specifically, the energy capacities S1_GFM and S2_GFM are calculated by the following equation.

$$S\_GFM = ST\_GFL ( t ) \times A ( t ) . \qquad ( 2 )$$

In the equation (2), the energy capacity S_GFM (t) is configured to indicate the energy capacity of the microgrid operating under the GFM operating mode at the time t, such as the total energy capacities S1_GFM and S2_GFM.

In some embodiments, the parameter A (t) is configured to indicate a convertibility percentage of the multiple inverter devices switching from the GFL operating mode to the GFM operating mode. In some embodiments, the parameter A is represented by percentage or decimal point, such as 20% or 0.2. However, the present disclosure is not limited to these representation and values.

In some embodiments, the percentage value of the parameter A is proportional to a quantity of the inverter devices operating under the GFM operating mode. Specifically, when the quantity of the inverter devices that are switched from the GFL operating mode to the GFM operating mode is increased, the percentage value of the parameter A increases. When the quantity of the inverter devices that are switched from the GFL operating mode to the GFM operating mode is decreased, the percentage value of the parameter A decreases.

For example, in the equation (2), when each of the inverter devices 112-116 is operating under the GFL operating mode, the total energy capacity ST1_GFL of the microgrid 110 has 50 MWh. In some circumstances, when one of the inverter devices 112-116 is switching from the GFL operating mode to the GFM operating mode, the parameter A has the convertibility percentage 20%. At this moment, the energy capacity S1_GFM of the microgrid 110 is equal to 50 MWh multiplied by 20%, which is 10 MWh. In some other circumstances, when more than one of the inverter devices 112-116 are switching from the GFL operating mode to the GFM operating mode, the parameter A has the convertibility percentage 90%. At this moment, the energy capacity S1_GFM of the microgrid 110 is equal to 50 MWh multiplied by 90%, which is 45 MWh.

In some embodiments, the calculation of the total energy capacity ST2_GFL and the energy capacity S2_GFM of the microgrid 210, and the relationship between the operating mode of the inverter devices 212-216 with the total energy capacity ST2_GFL and energy capacity S2_GFM are similar to the microgrid 110. The calculation of the total energy capacity ST2_GFL and the energy capacity S2_GFM are not repeated herein for simplicity. The electric power system 200 performs the operation 305 after the operation 304 is performed.

In the operation 305, the controllers 111 and 211 respectively calculate total state of charges when the inverter devices 112-116 and 212-216 are operating under the GFM operating mode and the GFL operating mode.

Specifically, the controller 111 calculates the energy capacity S1_GFM of which a part of the inverter devices 112-116 is operating under the GFM operating mode, and the energy capacity S1_GFL of which the other part of the inverter devices 112-116 remains operating under the GFL operating mode. The controller 211 calculates the energy capacity S2_GFM of which a part of the inverter devices 212-216 is operating under the GFM operating mode, and the energy capacity S2_GFL of which the other part of the inverter devices 212-216 remains operating under the GFL operating mode.

In some embodiments, the energy capacities S1_GFM and S2_GFM are calculated through the equation (2). The energy capacities S1_GFL and S2_GFL can be calculated by the following equation.

$$S\_GFL ( t ) = ST\_GFL ( t ) \times ( 1 - A ( t ) ) . \qquad ( 3 )$$

In the equation (3), the energy capacity S_GFL (t) is configured to indicate the energy capacity of the microgrid when one or more of the inverter devices remain operating under the GFL operating mode at time t, such as the energy capacities S1_GFL and S2_GFL.

In some embodiments, the operating mode of the multiple inverter devices can be switched according to the load capacity S_Load of the loads. Specifically, when a part of the inverter devices is operating under the GFL operating mode, the microgrid has the energy capacity S_GFL. When the other part of the inverter devices is operating under the GFM operating mode, the microgrid has the energy capacity S_GFM. At this moment, the sum of the energy capacities S_GFL and S_GFM is required to be larger than or equal to the load capacity S_Load, and satisfies the following equation.

$$S\_GFL ( t ) + S\_GFM ( t ) \geq S\_Load ( t ) \qquad ( 4 )$$

As illustratively shown in the equation (4), the sum of the energy capacities S_GFL and S_GFM at time t is larger than or equal to the load capacity S_Load required by the loads at time t.

For example, the loads N11 and N12 have the load capacities S_N11 and S_N12 respectively at time t. When a part of the inverter devices 112-116 is operating under the GFL operating mode, and the other part of the inverter devices 112-116 is operating under the GFM operating mode, the microgrid 110 has the energy capacities S1_GFL and S1_GFM. At this moment, the sum of each of the energy capacities S1_GFL and S1_GFM is requited to be larger than or equal to the sum of each of the loads capacities S_N11 and S_N12. The operation of the microgrid 210 is similar to the operation of the microgrid 110, and thus the discussion regarding the load capacity of the microgrid 210 is not repeated herein for simplicity.

In some embodiments, a part of the loads can further be categorized into essential loads, and the other part of the loads can further be categorized into non-essential loads. Correspondingly, the load capacity S_Load can further be categorized into an essential load capacity SC_Load of the essential loads and a non-essential load capacity SNC_Load of the non-essential loads, and satisfies the following equation.

$$S\_Load ( t ) = SC\_Load ( t ) + SNC\_Load ( t ) \qquad ( 5 )$$

As illustratively shown in the equation (5), the load capacity S_Load required by the loads in the microgrid at time t is equal to the sum of each of the essential load capacity SC_Load and the non-essential the load capacity SNC_Load.

For example, in the microgrids 110 and 210, a part of the loads N11, N12, N21 and N22 can be essential loads, such as the loads N11 and N21. The other part of the loads N11, N12, N21 and N22 can be non-essential loads, such as the loads N12 and N22. However, the present disclosure is not limited to this example.

In some embodiments, the essential load capacity SC_Load is configured to indicate the load capacity required by the essential loads. The essential loads may include hospital, city hall, military facilities, banks or other similar electrical facilities, but the present disclosure is not limited to above mentioned essential facilities. The non-essential load capacity SNC_Load is configured to indicate the load capacity required by the non-essential loads. The non-essential loads may include general residential electricity, charging station or other similar electrical facilities, but the present disclosure is not limited to above mentioned non-essential facilities. The electric power system 200 performs the operation 306 after the operation 305 is performed.

In the operation 306, the controllers 111 and 211 determine whether the utility power grid 130 and the lanes L1 and L2 connecting to the utility power grid 130 are abnormal.

Specifically, the controller 111 determines whether the lane L1 is abnormal according to the voltage V_CB10, the current I_CB10 and the frequency F_CB10. Similarly, the controller 211 determines whether the lane L2 is abnormal according to the voltage V_CB20, the current I_CB20 and the frequency F_CB20.

In some embodiments, when the voltage level of the voltage V_CB10 is lower than or equal to a lower limit voltage level V_limL, or when the voltage level of the voltage V_CB10 is higher than or equal to an upper limit voltage level V_limH, the controller 111 determining the lane L1 is abnormal. When the current level of the current I_CB10 is higher than a critical current level I_lim, the controller 111 determining the lane L1 is abnormal. When the frequency F_CB10 lower than or equal to a lower limit frequency F_limL, or when the frequency F_CB10 is higher than or equal to an upper limit frequency F_limH, the controller 111 determining the lane L1 is abnormal.

Correspondingly, when the voltage level of the voltage V_CB20 is lower than or equal to the lower limit voltage level V_limL, or when the voltage level of the voltage V_CB20 is higher than or equal to the upper limit voltage level V_limH, the controller 211 determining the lane L2 is abnormal. When the current level of the current I_CB20 is higher than the critical current level I_lim, the controller 211 determining the lane L2 is abnormal. When the frequency F_CB20 lower than or equal to the lower limit frequency F_limL, or when the frequency F_CB20 is higher than or equal to the upper limit frequency F_limH, the controller 211 determining the lane L2 is abnormal.

In some embodiments, when the controllers 111 and 211 respectively determine the lanes L1 and L2 are abnormal, the controllers 111 and 211 determine the utility power grid 130 is abnormal, and the electric power system 200 performs the operation 307 after the operation 306 is performed.

In some embodiments, when the controllers 111 and 211 respectively determine the lanes L1 and L2 are normal, the controllers 111 and 211 determine the utility power grid 130 is normal, and the electric power system 200 repeats the operation 302 after the operation 306 is performed.

In the operation 307, the controllers 111 and 211 cut off the switches CB10 and CB20 connecting to the utility power grid 130, and transmit commands to the inverter devices.

Specifically, when the controllers 111 and 211 cut off the switches CB10 and CB20 connecting to the utility power grid 130, the microgrids 110 and 210 are islanded operating. At this moment, the controller 111 transmits the commands to the inverter devices 112-116 respectively through the signals S1-S5. The controller 211 transmits the commands to the inverter devices 212-216 respectively through the signals S6-S10.

In some embodiments, the operation of the commands mentioned above includes switching the inverter devices 112-116 and 212-216 from the GFL operating mode to the GFM operating mode, and sets the voltages of the inverter devices 112-116 and 212-216 to the corresponding rated output voltage level V_DEF. However, the commands may include other similar parameters and settings; the present disclosure is not limited to the commands mentioned above. The electric power system 200 performs the operation 308 after the operation 307 is performed.

In the operation 308, the controllers 111 and 211 switch a part of the inverter devices to the GFM operating mode and the GFL operating mode.

Specifically, the controller 111 switches one or more of the inverter devices 112-116 from the GFL operating mode to the GFM operating mode respectively through the signals S1-S5. The controller 211 switches one or more of the inverter devices 212-216 from the GFL operating mode to the GFM operating mode respectively through the signals S6-S10.

In some embodiments, since the module and arrangement of the inverter devices are different, such that the energy capacities provided by the inverter devices operating under the GFM operating mode are different. Therefore, the energy capacity S_GFM that the microgrid can provide to the loads is different. For example, in some circumstances, the energy capacity S1_GFM that the microgrid 110 can provide under the GFM operating mode is smaller than the load capacity S1_Load required by the loads N11 and N12. In some other circumstances, the energy capacity S2_GFM that the microgrid 210 can provide under the GFM operating mode is larger than the load capacity S2_Load required by the loads N21 and N22.

In the circumstance mentioned above, the disclosed controllers 111 and 211 can switch a part of the inverter devices 112-116 and 212-216 from the GFL operating mode to the GFM operating mode to provide power to the loads N11, N12, N21, and N22 according to methods of a total load capacity determination, an essential load capacity provided under the GFM operating mode determination, and an essential load capacity provided under the GFL and the GFM operating modes determination.

In the method of the total load capacity determination, when the controller calculates that the energy capacity S_GFM is larger than the load capacity S_Load required by the loads, one or multiple inverter devices are switched to the GFM operating mode, and are configured to provide power to the loads. The method of the total load capacity determination satisfies the following equation.

$$S\_GFM ( t ) \geq S\_Load ( t )$$

$$S\_GFL ( t ) = ST\_GFL ( t ) \times ( 1 - A ( t ) )$$

Specifically, when the energy capacity S_GFM of the microgrid at time t is larger than the load capacity S_Load at time t, the energy capacity S_GFM of the inverter devices operating under the GFM operating mode can provide power to the loads in the microgrid. At this moment, the energy capacity S_GFL that the inverter devices operating under the GFL operating mode is equal to the total energy capacity ST_GFL subtracting the energy capacity that has been switched to the GFM operating mode, that is the total energy capacity ST_GFL multiplied by the parameter A.

For example, when the controller 111 calculates that the energy capacity S1_GFM of the microgrid 110 at time t is larger than the load capacity S_Load required by each of the loads N11 and N12, a part of the inverter devices 112-116 is operating under the GFM operating mode to provide power to each of the loads N11 and N12.

In the method of the essential load capacity provided under the GFM operating mode determination, when the controller calculates that the energy capacity S_GFM is larger than the essential loads capacity SC_Load of the essential loads, one or multiple inverter devices are switched to the GFM operating mode, and is configured to provide power to the essential loads. The method of the essential load capacity provided under the GFM operating mode determination satisfies the following equation.

$$S\_GFM ( t ) \geq SC\_Load ( t )$$

$$S\_GFL ( t ) = ST\_GFL ( t ) \times ( 1 - A ( t ) )$$

Specifically, when the energy capacity S_GFM of the microgrid at time t is larger than the essential loads capacity SC_Load, the energy capacity S_GFM of one or multiple inverter devices operating under the GFM operating mode can provide power to the essential loads in the microgrid. At this moment, the energy capacity S_GFL of the inverter devices operating under the GFL operating mode is equal to the total energy capacity ST_GFL subtracting the energy capacity that has been switched to the GFM operating mode, that is the total energy capacity ST_GFL multiplied by the parameter A.

For example, when the load N11 is the essential load, the load N12 is the non-essential load, and when the controller 111 calculates the energy capacity S1_GFM of the microgrid 110 at time t is larger than the essential loads capacity SC_Load required by the load N11, a part of the inverter devices 112-116 is switched to the GFM operating mode, and the other part of the inverter devices 112-116 is operating under the GFL operating mode to jointly provide power to the loads N11 and N12. In the example mentioned above, when the load capacity required by the load N11 changes, such as the load capacity increases, the inverter devices that are operating under the GFM operating mode are configured to output power according to the changed load capacity of the load N11, so as to absorb the changes of the load capacity required the load N11. At this moment, the inverter devices operating under the GFM operating mode and the GFL operating mode remain jointly providing power to the loads N11 and N12.

In some circumstances, when the microgrid 110 is operating, the inverter devices 112-114 operate under the GFM operating mode, the energy capacity of the inverter devices 112-114 is sufficient to cover the changes of the load capacity of the load N11. Relatively, the inverter devices 115-116 operate under the GFL operating mode. At this moment, the inverter devices 115-116 are operating in the maximum power output to follow, or output powers according to the deployment of the inverter devices operating under the GFM operating mode.

In some other circumstances, when the microgrid 110 is operating, and the energy capacity of the inverter devices 112-114 operating under the GFM operating mode is not sufficient to cover the change of the load capacity of the load N11, the inverter devices 115-116 can further be switched to the GFM operating mode to absorb the change of the load capacity of the load N11. In the method of the essential load capacity provided under the GFM operating mode determination, the inverter devices 112-116 are jointly configured to provide power to each of the loads N11 and N12.

In some embodiments, whether the inverter devices, such as the inverter devices 112-116, can be switched to the GFM operating mode is determined according to the actual functionality of the inverter devices.

In the method of the essential load capacity provided under the GFL and the GFM operating modes determination, when the controller calculates that the energy capacity S_GFM is smaller than the essential loads capacity SC_Load of the essential loads, yet the sum of each of the energy capacities S_GFM and S_GFL is larger than the essential loads capacity SC_Load of the essential loads, each of the inverter devices is switched to the GFM operating mode or the GFL operating mode to provide power to the essential loads. The method of the essential load capacity provided under the GFL and the GFM operating modes determination satisfies the following equation.

$$S\_GFM ( t ) + S\_GFL ( t ) \geq SC\_Load ( t )$$

$$S\_GFL ( t ) = ST\_GFL ( t ) \times ( 1 - A ( t ) )$$

Specifically, when the sum of the energy capacities S_GFM and S_GFL of the microgrid is larger than the essential loads capacity SC_Load, each of the inverter devices is operating under the GFM operating mode and the GFL operating mode, and jointly provides power to the essential loads in the microgrid. At this moment, the energy capacity S_GFL of the inverter devices operating under the GFL operating mode is equal to the total energy capacity ST_GFL subtracting the energy capacity that has been switched to the GFM operating mode, that is the total energy capacity ST_GFL multiplied by the parameter A.

For example, when the load N11 is the essential loads, the load N12 is the non-essential loads, and when the controller 111 calculates that the energy capacity S1_GFM of the microgrid at time t is smaller than the essential loads capacity SC_Load required by the load N11, a part of the inverter devices 112-116 is operating under the GFM operating mode, the other part of the inverter devices 112-116 remains operating under the GFL operating mode to provide the energy capacity S1_GFL and jointly provide power to the loads N11 and N12. In some embodiments, since the energy capacities S1_GFM and S1_GFL are just sufficient to provide electricity to the loads N11 and N12. At this moment, when the load capacity required by the essential loads N11 changes, the changes of the load capacity of the load N11 cannot be absorbed by the inverter devices 112-114.

In some circumstances, when the changes of the load capacity of the load N11 cannot be absorbed by the inverter devices 112-114 operating under the GFM operating mode, and the inverter devices 112-114 cannot immediately adjust the output voltage according to the changes of the load capacity, a voltage imbalance may occur on the bus BS110.

In some other circumstances, when the load capacity due to the changes of the loads N11 and N12 is larger than the energy capacity that the inverter devices 112-116 can provide, the microgrid 110 is also able to maintain providing power by the inverter devices 112-116 through shedding the non-essential load N12. However, the present disclosure is not limited to the circumstances mentioned above.

In some embodiments, the determination methods mentioned above are provided only for some embodiments of the disclosed microgrids 110 and 210, but the present disclosure is not limited to this. In various embodiments, the microgrids 110 and 210 can still be able to control the operating mode of the inverter devices according to various determination methods. The electric power system 200 performs the operation 309 after the operation 308 is performed.

In the operation 309, each of the inverter devices 112-116 and 212-216 transmits multiple state parameters of which the inverter devices have been switched to GFM operating mode and GFL operating mode back to the controllers 111 and 211.

Specifically, the state parameters mentioned above include output voltages V112-V116 and V212-V216, active powers P112-P116 and P212-P216, reactive powers Q112-Q116 and Q212-Q216 and the operating modes corresponding to the inverter devices 112-116 and 212-216. The inverter devices 112-116 and 212-216 transmit the corresponding output voltages V112-V116 and V212-V216 to the controllers 111 and 211, respectively. The inverter devices 112-116 and 212-216 further transmit the corresponding operating mode respectively to the controllers 111 and 211. The electric power system 200 performs the operation 310 after the operation 309 is performed.

In the operation 310, the controllers 111 and 211 determines whether the state parameters of the inverter devices 112-116 and 212-216 after switching the operating mode are the same as the commands.

Specifically, the controller 111 determines whether the voltage levels of the output voltages V112-V116 are equal to an output voltage level V_DEF, whether the active powers P112-P116 and the reactive powers Q112-Q116 are the same as the commands, and whether the operating modes of the inverter devices 112-116 and 212-216 are the same as the commands. The controller 211 determines whether the voltage levels of the output voltages V212-V216 are equal to the output voltage level V_DEF, and the operating mode of the inverter devices 212-216 are the same as the commands.

In some embodiments, when the controllers 111 and 211 determine the output voltages V112-V116 and V212-V216, the active powers P112-P116 and P212-P216, the reactive powers Q112-Q116 and Q212-Q216, and the operating modes of the inverter devices 112-116 and 212-216 are the same as the commands, the electric power system 200 performs the operation 311. When the controllers 111 and 211 determine the output voltages V112-V116 and V212-V216, the active powers P112-P116 and P212-P216, the reactive powers Q112-Q116 and Q212-Q216, and the operating modes of the inverter devices 112-116 and 212-216 are not the same as the commands, the electric power system 200 performs the operation 312.

For example, when the commands of which the controller 111 transmits to the inverter device 112 in the operation 307 includes the rated output voltage level V_DEF and the GFM operating mode, and the rated output voltage level V_DEF has 50 volts, the controller 111 determines whether the voltage level of the output voltages V112 is equal to 50 volts, and whether the active powers P112 and the reactive powers Q112 are equal to the values of the commands, and whether the inverter device 112 is operating under the GFM operating mode. When the controller 111 determining the voltage level of the output voltages V112 is equal to 50 volts, and the inverter device 112 is operating under the GFM operating mode, the controller 111 determining the output voltages V112 and the operating mode of the inverter device 112 are the same as the commands.

Relatively, when the controller 111 determining the voltage level of the output voltages V112 is not equal to 50 volts, and/or the inverter device 112 is not operating under the GFM operating mode, the controller 111 determining the output voltages V112 and/or the operating mode are not the same as the commands.

In the operation 311, the microgrids 110 and 210 are islanded operated, and provide power to the loads N11, N12, N21 and N22.

Specifically, when the controller 111 determining the output voltages V112-V116 and the operating mode of the inverter devices 112-116 are the same as the commands, the switch CB10 remains cut off, the microgrid 110 is configured to provide power to the loads N11 and N12. When the controller 211 determining the output voltages V212-V216 and the operating mode of the inverter devices 212-216 are the same as the commands, the switch CB20 remains cut off, and the microgrid 210 is configured to provide power to the loads N21 and N22. The electric power system 200 completes the operation method 300 after the operation 311 is performed.

In the operation 312, the inverter devices 112-116 and 212-216 perform a parametric compensation.

Specifically, when the controller 111 determining the output voltages V112-V116, the active powers P112-P116, the reactive powers Q112-Q116, and the operating mode of the inverter devices 112-116 are not the same as the commands, the controller 111 transmits the commands to the inverter devices 112-116 respectively through the signals S1-S5 once again. When the controller 211 determining the output voltages V212-V216, the active powers P212-P216, the reactive powers Q212-Q216, and the operating mode of the inverter devices 212-216 are not the same as the commands, the controller 211 transmits the commands to the inverter devices 212-216 respectively through the signals S6-S10 once again. The electric power system 200 repeats the operation 309 after the operation 312 is performed.

In some approaches, since the infrastructure of the utility power grid and the microgrid utilize the feeder cables for the microgrid to receive the power supply and as the power distribution path. The utility power grid usually provides electricity to the microgrid and the microgrid provides power to the loads. When power lines or the utility power grid at the upstream of the feeder cables is abnormal, the powers can only be supplied to the loads through the islanded microgrid at the downstream. Not until the abnormality is resolved did the utility power grid is reconnected to the microgrid. However, when the energy capacity that the islanded microgrid can provide is insufficient, the power demand of the loads can only be lowered by load shedding. The power supply in some emergencies or essential facilities may as a result be interrupted.

Compared to the approaches above, in the embodiments of the present disclosure, the electric power systems 100 and 200 can control the inverter devices 112-116 and 212-216 to switch the operating mode through the signals S1-S10 implemented by the GOOSE communication lines. When abnormalities occur to the lanes L1 and L2 connecting to the utility power grid 130, the inverter devices 112-116 and 212-216 are switched from the GFL operating mode to the GFM operating mode according to the signals S1-S10, such that the islanded microgrids 110 and 210 remains providing power to the loads N11, N12, N21 and N22. The disclosed electric power systems 100 and 200 can further prevent the emergencies or essential facilities from electricity shortage due to the abnormality of the utility power grid.

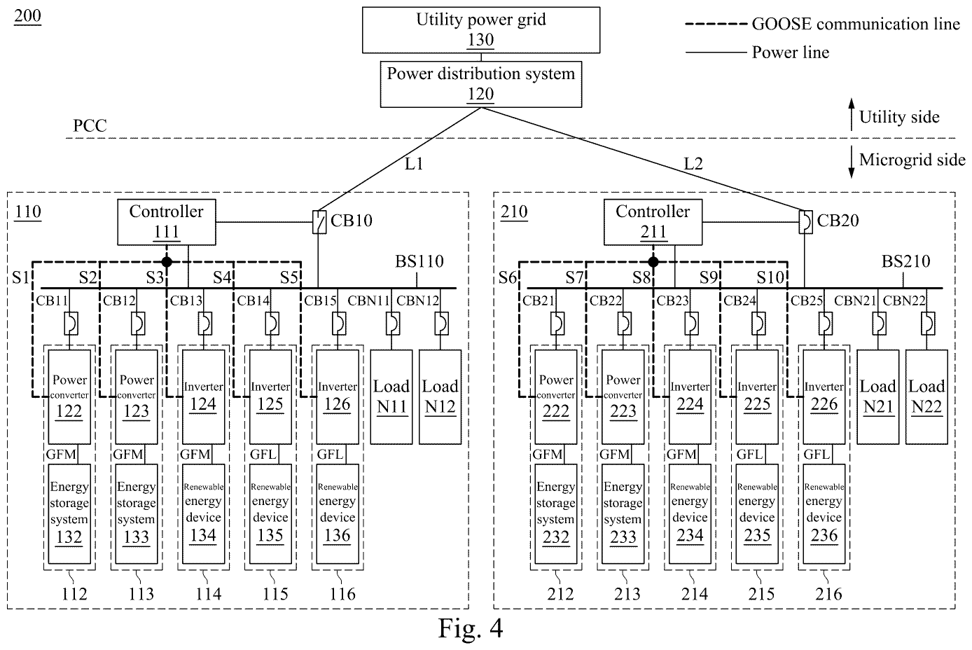

FIG. 4 is a schematic diagram of the electric power system 200, illustrated in accordance with some embodiments of the present disclosure. As illustratively shown in FIG. 4, the switch CB10 in the microgrid 110 has been cut off, and the switch CB20 in the microgrid 210 is thrown in.

Referring to FIG. 4 and FIG. 3, in the circumstances of the FIG. 4, the controller 111 determines that the lane L1 is abnormal in the operation 306, ant cuts off the switch CB10. At this moment, the controller 111 transmits the commands to the inverter devices 112-116 respectively through the signals S1-S5 to switch each of the inverter devices 112-114 to the GFM operating mode, and keeps each of the inverter devices 115-116 operate under the GFL operating mode. When the inverter devices 112-114 are operating under the GFM operating mode, the microgrid 110 has the energy capacity S1_GFM provided by the inverter devices 112-114. When the inverter device 115-116 are operating under the GFL operating mode, the microgrid 110 has the energy capacity S1_GFL provided by the inverter devices 115-116.

In some circumstances, when the load N11 is the essential loads, and the load N12 is the non-essential loads, the load N11 has the essential load capacity SC_Load, and the load N12 has the non-essential load capacity SNC_Load. At this moment, when the energy capacity S1_GFM is larger than the load capacity S_Load, which is the sum of the essential loads capacity SC_Load and the non-essential loads capacity SNC_Load, the inverter devices 112-114 are configured to provide power to each of the loads N11 and N12. Specifically, the energy capacity S1_GFM provided by the inverter devices 112-114 is provided to each of the loads N11 and N12.

In some embodiments, when the energy capacity S1_GFM is larger than the essential loads capacity SC_Load, and is smaller than the load capacity S_Load, the inverter devices 112-114 operate under the GFM operating mode, the inverter devices 115-116 operate under the GFL operating mode to provide power to the loads N11 and N12. Wherein, the inverter devices 112-114 are configured to absorb the changes of the load capacity of the load N11. Specifically, when the inverter devices 112-114 are operating under the GFM operating mode, the energy capacity S1_GFM provided by the microgrid 110 is larger than the load capacity required by the load N11. At this moment, the inverter devices 112-116 are jointly providing power to each of the loads N11 and N12. At this moment, when the load capacity of the load N11 changes, the inverter devices 112-114 can be configured to absorb the changes of the load capacity of the load N11.

In some other embodiments, when the energy capacity S1_GFM is smaller than the essential loads capacity SC_Load, each of the inverter devices 112-116 is configured to provide power to the loads N11 and N12. When the load capacity required by the changes of the loads N11 and N12 is larger than the energy capacity that the inverter devices 112-116 can provide, the voltage may abruptly drop. The controller 111 cuts off the switch CBN12, and the microgrid 110 stop providing power to the load N12, such that the energy capacity generated by each of the inverter devices 112-116 is sufficient to be provided to the load N11. Specifically, the energy capacity S1_GFM provided by the inverter devices 112-114 operating under the GFM operating mode and the energy capacity S1_GFL provided by the inverter device 115-116 operating under the GFL operating mode are configured to be provided to each of the loads N11 and N12. When the load capacity of the load N11 changes, the inverter devices 112-114 are unable to adjust the provided energy capacity S1_GFM to absorb the changes of the load capacity of the load N11. At this moment, the controller 111 sheds the load N12, such that the energy capacity S1_GFM is sufficient to be provided to the essential loads N11.

In some other circumstances, when the load N11 is the non-essential loads, and the load N12 is the essential loads, the load N12 has the essential loads capacity SC_Load, the load N11 has the non-essential loads capacity SNC_Load. At this moment, the operation of the microgrid 110 is similar to the previously mentioned circumstances, with only switching the load N11 with the load N12. Therefore, the similarities are not repeated herein for simplicity.

Referring to FIG. 4 and FIG. 4, in the circumstances of FIG. 4, the controller 211 determining the lane L2 is normal in the operation 306. At this moment, the switch CB20 remains thrown in, and the utility power grid 130 keeps providing electricity to the microgrid 210 so as to provide power to the loads N21 and N22.

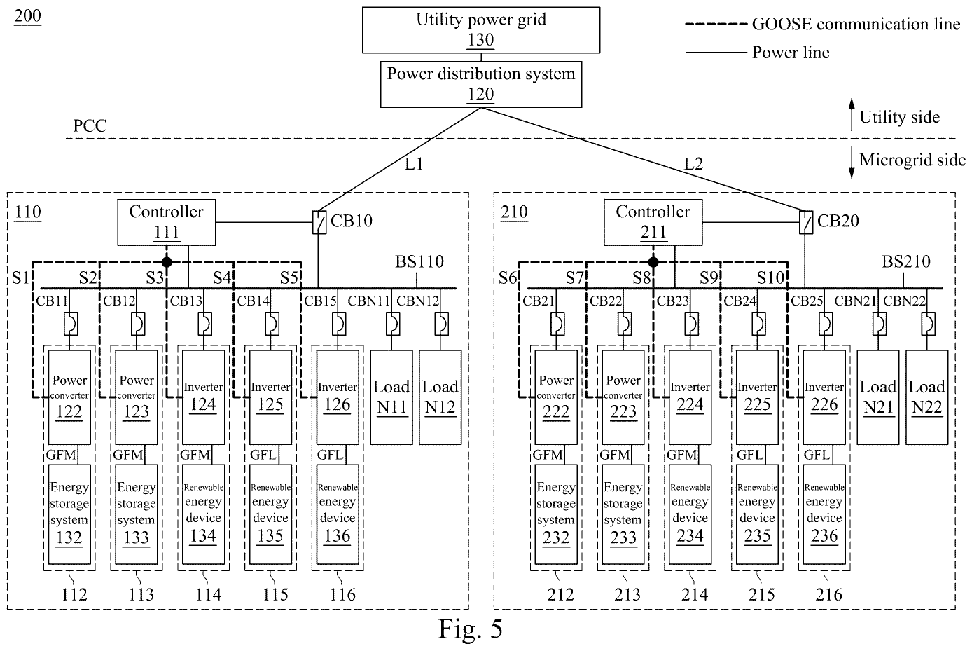

FIG. 5 is a schematic diagram of the electric power system 200, illustrated in accordance with some embodiments of the present disclosure. As illustratively shown in FIG. 5, each of the switch CB10 in the microgrid 110 and the switch CB20 in the microgrid 210 has been cut off.

Referring to FIG. 5 and FIG. 3, in the circumstances of FIG. 5, the controller 111 determining the lane L1 is abnormal in the operation 306, and cuts off the switch CB10. The controller 211 determining the lane L2 is abnormal, and cut off the switch CB20.

At this moment, the controller 111 transmits the commands to the inverter devices 112-116 respectively through the signals S1-S5 to switch each of the inverter devices 112-114 to the GFM operating mode, and keeps each of the inverter devices 115-116 operating under the GFL operating mode. Relatively, the controller 211 transmits the commands to the inverter devices 212-216 respectively through the signals S6-S10 to switch each of the inverter devices 212-214 to the GFM operating mode, and keeps each of the inverter devices 215-216 operating under the GFL operating mode.

In some embodiments, when each of the inverter devices 112-114 and 212-214 remains operating under the GFM operating mode, the microgrid 110 has the energy capacity S1_GFM provided by the inverter devices 112-114, and the microgrid 210 has the energy capacity S2_GFM provided by the inverter devices 212-214. When each of the inverter devices 115-116 and 215-216 is operating under the GFL operating mode, the microgrid 110 has the energy capacity S1_GFL provided by the inverter device 115-116, and the microgrid 210 has the inverter device 215-216 the energy capacity S2_GFL.

In some circumstances, when the loads N11 and N21 are the essential loads, and the loads N12 and N22 are the non-essential loads, the load N11 and N21 have the essential loads capacities SC1_Load and SC2_Load respectively, the loads N12 and N22 have the non-essential loads capacities SNC1_Load and SNC2_Load respectively.

At this moment, when the energy capacity S1_GFM is larger than the load capacity S1_Load, which is the sum of the essential loads capacity SC1_Load and the non-essential loads capacity SNC1_Load, the inverter devices 112-114 are configured to provide power to each of the loads N11 and N12. Specifically, the energy capacity S1_GFM of the inverter devices 112-114 is configured to be provided to each of the loads N11 and N12. Relatively, when the energy capacity S2_GFM is larger than the load capacity S2_Load, which is the essential loads capacity SC2_Load and the non-essential loads capacity SNC2_Load, the inverter devices 212-214 are configured to provide power to each of the loads N21 and N22. Specifically, the energy capacity S2_GFM of the inverter device 212-214 is configured to be provided to each of the loads N21 and N22.

In some embodiments, when the energy capacity S1_GFM is larger than the essential loads capacity SC1_Load, and is smaller than the load capacity S1_Load, the inverter devices 112-114 operate under the GFM operating mode, and the inverter devices 115-116 operate under the GFL operating mode, and jointly provide power to the loads N11 and N12. Specifically, the energy capacity S1_GFM of the inverter devices 112-114 and the energy capacity S1_GFL of the inverter devices 115-116 are configured to jointly provide power to the loads N11 and N12. At this moment, when the energy capacity required by the load N11 changes, the inverter devices 112-114 operating under the GFM operating mode can further absorb the changes of the energy capacity required by the load N11. Relatively, when the energy capacity S2_GFM is larger than the essential load capacity SC2_Load, and is smaller than the load capacity S2_Load, the inverter devices 212-214 operate under the GFM operating mode, and the inverter devices 215-216 operate under the GFL operating mode to jointly provide power to the loads N21 and N22. Specifically, the energy capacity S2_GFM of the inverter devices 212-214 and the energy capacity S2_GFL of the inverter devices 215-216 are configured to jointly provide power to the loads N21 and N22. At this moment, when the energy capacity required by the loads N21 changes, the inverter device 212-214 operating under the GFM operating mode can further absorb the change of the energy capacity required by the loads N21.

In some other embodiments, when the energy capacity S1_GFM is smaller than the essential loads capacity SC1_Load, each of the inverter devices 112-116 is configured to provide power to the loads N11 and N12. When the load capacity required by the changes of the loads N11 and N12 is larger than the energy capacity that the inverter devices 112-116 can provide, the voltage may abruptly drop. The controller 111 cuts off the switch CBN12, such that the microgrid 110 stop providing power to the load N12. Specifically, the energy capacity S1_GFM of the inverter devices 112-114 and the energy capacity S1_GFL of the inverter device 115-116 are configured to be provided to the loads N11 and N12. When the energy capacity S1_GFM of the inverter devices 112-114 is not sufficient to absorb the changes of the energy capacity required by the load N11, the controller 111 sheds the load N12, such that the microgrid 110 maintains providing power to the load N11. Relatively, when the energy capacity S2_GFM is smaller than the essential loads capacity SC2_Load, each of the inverter devices 212-216 is configured to provide power to the loads N21 and N22. At this moment, the energy capacity of the inverter device 212-214 operating under the GFM operating mode are not sufficient to absorb the changes of the energy capacity of the load N21, the controller 211 cuts off the switch CBN22, such that the microgrid 210 stop providing power to the load N22. Specifically, the energy capacity S2_GFM of the inverter devices 212-214 and the energy capacity S2_GFL of the inverter devices 215-216 are configured to jointly provide power to the loads N21 and N22. When the energy capacity S2_GFM of the inverter devices 212-214 is not sufficient to absorb the changes of the load capacity of the load N21, the controller 211 sheds the load N22, such that the microgrid 210 maintains providing power to the load N21.

In some other circumstances, when the loads N11 and N21 are the non-essential loads and the loads N12 and N22 are the essential loads, the loads N12 and N22 have the essential loads capacities SC1_Load and SC2_Load respectively, and the loads N11 and N21 have the non-essential loads capacities SNC1_Load and SNC2_Load respectively. At this moment, the operation of the microgrids 110 and 210 is similar to the previously mentioned circumstances, with only switching the loads N11 and N21 with the loads N12 and N22. Therefore, the similarities are not repeated herein for simplicity.

Referring to FIG. 5 and FIG. 4, the present disclosure is not limited to switch the inverter devices 112-114 and 212-214 to the GFM operating mode. In various embodiments, each of the inverter devices 112-116 and 212-216 can be switched between the GFM operating mode and the GFL operating mode.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An electric power system, comprising:
an utility power grid connected to a first switch; and
a microgrid connected to the utility power grid through the first switch, the microgrid comprising:
a plurality of inverter devices connected to a bus;
a controller connected to the first switch and each of the plurality of inverter devices, and configured to transmit a plurality of first signals; and
a plurality of loads connected to the plurality of inverter devices through the bus,
wherein the utility power grid is connected to the bus through the first switch, and is configured to provide power to the plurality of loads,
the controller is further configured to detect a first lane connecting the utility power grid with the microgrid, and determine whether the first lane is abnormal, and
when the controller determines the first lane is abnormal, the controller cuts off the first switch, and switches a first part of the plurality of inverter devices to a voltage source configuration through the plurality of first signals.

2. The electric power system of claim 1, wherein
when the controller determining the first lane is normal, the first switch remains thrown in, and each of the plurality of inverter devices operates under a current source configuration being different from the voltage source configuration, and
when the controller determining the first lane is abnormal, a second part of the plurality of inverter devices operates under the current source configuration, and the second part is different from the first part.

3. The electric power system of claim 2, wherein the plurality of inverter devices comprising:
a plurality of power converters connected to the bus; and
a plurality of energy storage systems, respectively connected to the plurality of power converters,
wherein when the first part of the plurality of inverter devices is operating under the voltage source configuration, the plurality of energy storage systems corresponding to the first part of the plurality of power converters is configured to provide power to the plurality of loads.

4. The electric power system of claim 2, wherein the controller is further configured to:
calculate a first capacity of the first part, when the first part of the plurality of inverter devices is operating under the voltage source configuration, and
calculate a second capacity of the second part, when the second part of the plurality of inverter devices is operating under the current source configuration.

5. The electric power system of claim 4, wherein
when the first capacity is larger than a third capacity of the plurality of loads, the first part of the plurality of inverter devices is configured to provide power to each of the plurality of loads,
when the first capacity is smaller than the third capacity, and the first capacity is larger than a fourth capacity of a third part of the plurality of loads, the first part and the second part of the plurality of inverter devices is configured to provide power to the fourth capacity of the plurality of loads, and when the fourth capacity changes, the first part of the plurality of inverter devices is configured to absorb the change of the fourth capacity, and
when the first capacity is smaller than the fourth capacity, and when a sum of the first capacity and the second capacity is larger than the fourth capacity, each of the first part and the second part of the plurality of inverter devices is configured to provide power to the third capacity of the plurality of loads.

6. The electric power system of claim 4, wherein
when a voltage level of a voltage of the first switch is lower than a lower limit voltage level, or higher than an upper limit voltage, the controller determining the first lane is abnormal, and
when the first part of the plurality of inverter devices is switched to the voltage source configuration, each of the first part of the plurality of inverter devices transmits a plurality of state parameters to the controller,
the plurality of state parameters at least comprises an output voltage of each of the first part of the plurality of inverter devices.

7. The electric power system of claim 2, wherein the plurality of inverter devices further comprising:
a plurality of inverters connected to the bus; and
a plurality of renewable energy devices, respectively connected to the plurality of inverters,
wherein when the first part of the plurality of inverter devices is operating under the voltage source configuration, the plurality of renewable energy devices corresponding to the first part of the plurality of inverters is configured to provide power to the plurality of loads.

8. The electric power system of claim 1, wherein the plurality of first signals are transmitted to the plurality of inverter devices by a GOOSE (Generic Object Oriented Substation Event) virtual channel communication technology.

9. A method for operating an electrical power system, comprising:
connecting an utility power grid to a plurality of microgrids respectively through a plurality of lanes by a plurality of switches;
detecting a plurality of voltages of the plurality of switches, and determining whether the plurality of lanes are abnormal according to the plurality of voltages;
when determining a first lane of the plurality of lanes is abnormal, cutting off a first switch of the plurality of switches, and switching a first part of a plurality of inverter devices in a first microgrid of the plurality of microgrids to a voltage source configuration; and
when determining the first lane is normal, remained throwing in the first switch, and each of the plurality of inverter devices operates under a current source configuration being different from the voltage source configuration,
wherein when determining the first lane is abnormal, a second part the plurality of inverter devices operate under the current source configuration, and the second part is different from the first part.

10. The method of claim 9, further comprising:
when determining a second lane of the plurality of lanes is abnormal, and the first lane is normal, cutting off a second switch of the plurality of switches, and switching a third part of a plurality of inverter devices in a second microgrid of the plurality of microgrid to the voltage source configuration; and
when determining the second lane is normal, remained throwing in the second switch, and each of and the plurality of inverter devices operates under the current source configuration being different from the voltage source configuration,
wherein when determining the second lane is abnormal, a fourth part of the plurality of inverter devices operate under the current source configuration, and the fourth part is different from each of the first part, the second part, and the third part, and
when determining the second lane is abnormal and the first lane is normal, each of the first part and the second part of the plurality of inverter devices operates under the current source configuration.

11. The method of claim 10, further comprising:
calculating a first capacity of the first part operating under the voltage source configuration, and a second capacity of the second part operating under the current source configuration;
calculating a third capacity of the third part operating under the voltage source configuration, and a fourth capacity of the fourth part operating under the current source configuration,
wherein when the first capacity is larger than a fifth capacity of a plurality of loads in the first microgrid, the first part is configured to provide power to each of the plurality of loads,
when the third capacity smaller than a sixth capacity of a plurality of loads in the second microgrid, and the third capacity is larger than a seventh capacity of a seventh part of the plurality of loads in the second microgrid, each of the plurality of inverter devices is configured to provide power to each of the plurality of loads.

12. The method of claim 11, wherein
when the third capacity is larger than the sixth capacity, the third part is configured to provide power to each of the plurality of loads in the second microgrid.

13. The method of claim 12, wherein
when the seventh capacity changes, the third part of the plurality of inverter devices is configured to absorb changes of the seventh capacity, and
when the third capacity is smaller than seventh capacity, and when a sum of the third capacity and the fourth capacity is larger than seventh capacity, each of the third part and the fourth part of the plurality of inverter devices is configured to provide power to the sixth capacity of the plurality of loads.

14. The method of claim 10, wherein
the plurality of inverter devices comprises a plurality of inverters and a plurality of energy storage systems,
when the first part is operating under the voltage source configuration, the plurality of energy storage systems corresponding to the first part of the plurality of inverter devices are configured to provide power to a plurality of loads in the first microgrid, and
when the third part is operating under the voltage source configuration, the plurality of energy storage systems corresponding to the third part of the plurality of inverter devices are configured to provide power to a plurality of loads in the second microgrid.

15. The method of claim 10, wherein
the plurality of inverter devices comprising a plurality of inverters and a plurality of renewable energy devices,
when the first part is operating under the voltage source configuration, the plurality of renewable energy devices corresponding to the first part of the plurality of inverter devices are configured to provide power to a plurality of loads in the first microgrid, and
when the third part is operating under the voltage source configuration, the plurality of renewable energy devices corresponding to the third part of the plurality of inverter devices are configured to provide power to a plurality of loads in the second microgrid.

16. The method of claim 10, wherein
when a voltage level of a voltage of the first switch is lower than a lower limit voltage level, or higher than an upper limit voltage level, the first lane is determined to be abnormal, and
when the first part is switched to the voltage source configuration, each of the first part of the plurality of inverter devices transmits a plurality of first state parameters to a first controller of the first microgrid, the plurality of first state parameters at least comprises an output voltage of each of the first part of the plurality of inverter devices.

17. The method of claim 16, wherein
when a voltage level of a voltage of the second switch is lower than the lower limit voltage level, or higher than the upper limit voltage level, the second lane is determined to be abnormal, and
when the third part is switched to the voltage source configuration, each of the third part the plurality of inverter devices transmit a plurality of second state parameters to a second controller of the second microgrid, the plurality of second state parameters at least comprises an output voltage of each of the third part of the plurality of inverter devices.

18. The method of claim 17, wherein
the first controller switches the first part to the voltage source configuration through a plurality of first signals,
the second controller switches the third part to the voltage source configuration through a plurality of second signals, and
each of the plurality of first signals and the plurality of second signals is transmitted to the plurality of inverter devices by a GOOSE (Generic Object Oriented Substation Event) virtual channel communication technology.

19. The method of claim 18, further comprising:
when the plurality of first state parameters are transmitted back to the first controller, the first controller determines whether the corresponding plurality of first state parameters is the same as the plurality of first signals,
when the plurality of first state parameters is the same as the plurality of first signals, the first switch remains cut off, and the first part and the second part are configured to provide power to the plurality of loads of the first microgrid, and
when the corresponding output voltage of the plurality of first state parameters is not the same as the plurality of first signals, the first controller performs a parameter compensation to the plurality of inverter devices in the first microgrid.

20. The method of claim 19, further comprising:
when the plurality of second state parameters are transmitted back to the second controller, the second controller determines whether the corresponding plurality of second state parameters is the same as the plurality of second signals,
when the plurality of second state parameters is the same as the plurality of second signals, the second switch remains cut off, and the third part and the fourth part are configured to provide power to the plurality of loads of the second microgrid, and
when the corresponding output voltage of the plurality of second state parameters is not the same as the plurality of second signals, the second controller performs the parameter compensation to the plurality of inverter devices in the second microgrid.
